(19) United States
(12) Patent Application Publication
(10) Pub. No.: US 2025/0288024 A1
(43) Pub. Date: Sep. 18, 2025

(54) FOOTWEAR ITEM

(71) Applicant: OKAMOTO CORPORATION, Kitakatsuragi-gun, Nara (JP)

(72) Inventors: Masato FUKIAGE, Shiga (JP); Tomoya SUZUKI, Nara (JP); Natsuko KAGEYAMA, Osaka (JP); Masahiro SAWADA, Nara (JP); Kazuki AOYAGI, Hyogo (JP)

(21) Appl. No.: 18/862,333

(22) PCT Filed: Aug. 10, 2023
(86) PCT No.: PCT/JP2023/029258

§ 371 Date: Nov. 1, 2024

(30) Foreign Application Priority Data
Aug. 10, 2022 (JP) 2022-127570

(51) Int. Cl. A41B 11/02

(52) U.S. Cl. CPC A41B 11/02

(57) ABSTRACT

Problems for the present invention to be solved is to provide a footwear item that allows the wearer to more effectively perceive that an acupuncture point for insomnia is being stimulated, compared to conventional footwear items. A footwear item 100 according to the present invention is a footwear item for covering at least a human foot, and includes a heel covering portion 120 and a raised portion 125. There is at least one raised portion. This raised portion protrudes toward at least one of an inner side and an outer side of the heel covering portion. This raised portion has corners CN. The raised portion preferably has a polygonal shape, and more preferably has a cross shape when seen in plan view.

### TECHNICAL FIELD

The present invention relates to footwear items that can be worn at least on the feet, such as socks (socks, knee socks, or the like), leg warmers, stockings, tights, or the like.

### BACKGROUND ART

In the past, “socks with a raised portion formed in the heel pouch at a portion corresponding to the vicinity of the area called insomnia, which is an acupuncture point on the sole of the human foot,” has been proposed (for example, see Registered Utility Model No. 3210355). When worm, these socks are said to stimulate the acupuncture point for insomnia, soothe over-stimulated nerves, induce sleepiness, and improve problems such as loss of concentration or the like.

### PRIOR ART DOCUMENT

Patent Document 1: Registered Utility Model Publication No. 3210355

### SUMMARY OF INVENTION

### Problem to be Solved

By the way, the inventors' intensive studies have revealed that depending on the shape of the raised portion, it sometimes becomes difficult for the wearer to perceive that the acupuncture point for insomnia is being stimulated.

Problems for the present invention to be solved is to provide a footwear item that can make the wearer more effectively perceive that the acupuncture point for insomnia is being stimulated, as compared with conventional footwear items.

### DISCLOSURE OF INVENTION

A footwear item according to a first aspect of the present invention is a footwear item for covering at least a human foot, and includes a heel covering portion and a raised portion. Note that, the footwear item may cover only a part of a human's foot, or may cover the entire human's foot. Further, a leg covering portion for covering a human's leg may be added to the footwear item. The heel covering portion is a portion for covering part or all of the heel. There is at least one raised portion. The raised portion protrudes toward at least one of an inner side and an outer side of the heel covering portion. The raised portion has corner(s). Note that the term “corner” includes not only an angle formed by intersecting straight lines, but also an angle formed by a combination of a straight line and a curved line (circular arc, or the like), that is, a round corner. However, from the viewpoint of effectively stimulating the acupuncture point for insomnia, the radius of the rounded corner is preferably 15 mm or less. Although the lower limit of the radius of the rounded corner is not particularly defined, it is, for example, 0.1 mm. In addition, when the wearer's own weight is applied to the raised portion when the wearer exercises such as walking, the area on which the wearer's own weight is applied becomes smaller due to the presence of the corner(s), thus increasing the pressure applied to the acupuncture point.

As described above, in the footwear item, corner(s) are formed in the raised portion. A wearer of a footwear item is more likely to perceive contact with the footwear item having corner(s) than with one that is formed by a gentle curve or curved surface. For this reason, the footwear item can make the wearer perceive that the acupuncture point for insomnia is stimulated more effectively than previous footwear items when worn before bedtime or when the wearer walks lightly before bedtime. Note that, when the protrusion portion protrudes toward the outside of the heel covering portion, at least light exercise such as walking is required to stimulate the acupuncture point for insomnia with the protrusion portion for insomnia.

A footwear item according to a second aspect of the present invention is the footwear item according to the first aspect, wherein the raised portion has a polygonal shape.

For this reason, a plurality of corners are formed in the footwear item. Thus, the footwear item can make the wearer more effectively perceive that the acupuncture point for insomnia is being stimulated than the previous footwear item.

A footwear item according to a third aspect of the present invention is a footwear item according to the second aspect, wherein the raised portion has a cross shape in plan view. Note that “plan view” refers to looking through from directly above when the footwear item is placed flat with the heel covering portion facing downward.

Thus, in the footwear item, two relatively sharp corners are formed on each of the four sides in one raised portion. This allows the footwear item to stimulate the acupuncture point for insomnia in all four positions, and to stimulate the acupuncture point for insomnia even if the position of the raised portion is slightly shifted from the acupuncture point for insomnia when the foot attachment is worn.

A footwear item according to a fourth aspect of the present invention is the footwear item according to the third aspect, wherein the raised portion includes a rectangular portion, a first wing portion, and a second wing portion. The rectangular portion has a rectangular shape in plan view. The first wing portion extends from the rectangular portion toward both sides along a width direction. The second wing portion extends from the rectangular portion toward both sides in a direction perpendicular to the width direction in plan view. An upper end surface of the rectangular portion is located at a higher position than an upper end surface of the first wing portion and an upper end surface of the second wing portion. In other words, the rectangular portion is thicker than the first wing portion and the second wing portion.

Thus, in the footwear item, corners can also be formed even in the rectangular portion in the center. This allows for effectively stimulating the central part of the acupuncture point for insomnia when the footwear item is normally worn.

A footwear item according to a fifth aspect of the present invention is the footwear item according to any one of the first to fourth aspects, wherein the heel covering portion is formed of an inner knitted fabric layer and an outer knitted fabric layer. The raised portion is located between the inner knitted fabric layer and the outer knitted fabric layer.

Thus, with the footwear item, the wear or deterioration of the raised portion can be inhibited or reduced.

A footwear item according to a sixth aspect of the present invention is the footwear item according to the fifth aspect, wherein the raised portion includes a first protrusion portion and a second protrusion portion. The first protrusion portion protrudes from the inner knitted fabric layer toward the outer knitted fabric layer. The second protrusion portion protrudes from the outer knitted fabric layer toward the inner knitted fabric layer. The second protrusion is arranged to face the first protrusion portion.

Thus, in the footwear item, the raised portion with sufficient height can be formed using a relatively simple knitting structure.

A footwear item according to a seventh aspect of the present invention is the footwear item according to the first aspect, wherein this footwear item is for promoting sleep.

This allows a person wearing the footwear item to easily fall asleep.

A footwear item according to an eighth aspect of the present invention is the footwear item according to the seventh aspect, wherein this footwear item has a cylindrical shape with openings on both sides.

This allows the footwear item to make it possible to expose a blood vessel region (for example, an AVA blood vessel region, or the like) present on the toe side of the wearer's foot. Thus, the footwear item can sufficiently lower the wearer's core body temperature, and in turn can provide the wearer with a good quality sleep.

### BRIEF DESCRIPTION OF DRAWINGS

FIG. 1 is a side view of a sleep-promoting leg warmer according to an embodiment of the present invention.

FIG. 2 is a plan view of the sleep-promoting leg warmer according to the embodiment of the present invention when placed horizontally.

FIG. 3 is a longitudinal cross-sectional view of the first press fitting portion of the sleep-promoting leg warmer according to the embodiment of the present invention.

FIG. 4 is a plan view of a raised portion of the sleep-promoting leg warmer according to the embodiment of the present invention.

FIG. 5 is a diagram showing a method of knitting protrusion portions of the sleep-promoting leg warmer according to the embodiment of the present invention.

FIG. 6 is a plan view showing the shape of a raised portion of the sleep-promoting leg warmer according to modification (N).

### REFERENCE SIGNS LIST

100 Sleep-promoting leg warmer (footwear item)
120 First press fitting portion (heel covering portion)
120a Inner knitted fabric layer
120b Outer knitted fabric layer
125 Raised portion
125a First protrusion portion
125b Second protrusion portion
CN Corner(s)
RG Rectangular portion
W1 First wing portion
W2 Second wing portion

### DESCRIPTION OF EMBODIMENTS

### <Configuration of Footwear Item According to Embodiment of the Present Invention>

The footwear item according to an embodiment of the present invention is an item that can be worn on a human foot, and its examples include socks (foot covers, socks, knee socks), leg warmers, stockings, tights, and the like. Note that the “foot” refers to an area from the ankle to the toe. Moreover, this footwear item may cover only a part of a human's foot, or may cover the entire human's foot. Further, this foot item may include a leg covering portion for covering a human's legs, such as socks, knee socks, leg warmers, stockings, tights, or the like.

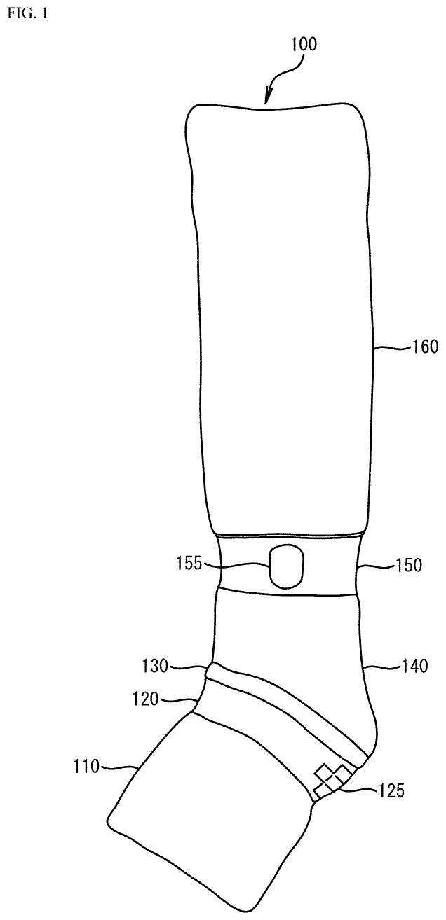

An example of the footwear item according to the embodiment of the present invention includes a sleep-promoting leg warmer 100 shown in FIG. 1. Note that this sleep-promoting leg warmer 100 has been invented to realize the three concepts shown in a), b), and c) below.
a) Warming the feet excluding the toes to inhibit or reduce the inconvenience of not being able to sleep due to cold feet.
b) Opening on the toe side to lower the wearer's core body temperature to induce sleepiness.
c) Stimulating the acupuncture point for insomnia located on the heel to activate the parasympathetic nerves to relax the wearer's body.

Hereinafter, this sleep-promoting leg warmer 100 will be described in detail, and further configurations acceptable in the present invention will be described.

The sleep-promoting leg warmer 100 according to an embodiment of the present invention is a knitted fabric having a substantially doglegged cylindrical shape with both ends open, and mainly includes, as shown in FIG. 1, a partial foot covering portion 110, a first press fitting portion 120, a connection portion 130, an ankle covering portion 140, a second press fitting portion 150, and a shin covering portion 160. These constituent portions will be described in detail below.

### (1) Partial Foot Covering Portion

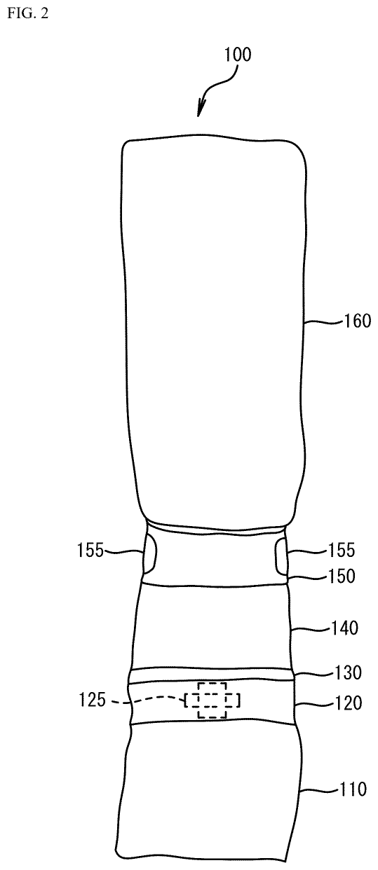

The partial foot covering portion 110 is a cylindrical portion having a double knitted fabric structure, covers the middle portion of the wearer's foot, and, for example, is a portion for covering an area equivalent to about 50% of the foot length (the distance from the heel end of the foot to the end of the longest toe). As described above, the partial foot covering portion 110 has a double knitted structure, and thus it has a heat retention function due to the air layer existing between the layers. As shown in FIGS. 1 and 2, one end of the partial foot covering portion 110 is the tip of the sleep-promoting leg warmer 100, and the other end is connected to the first press fitting portion 120. In other words, when the sleep-promoting leg warmer 100 is worn, the toe side of the wearer's feet will be exposed. The partial foot covering portion 110 is dimensionally designed for a person who has an average foot shape and whose foot length is within a range of 22 cm or more and 25 cm or less. In addition, a) in order to prompt the reduction of the wearer's core body temperature to lead to sleep by not covering areas where blood vessels in the legs are concentrated (for example, areas where AVA blood vessels are concentrated or the like), and also b) in order to slow the rate of temperature decrease in the feet to prevent sleep disturbance due to cold feet by covering areas other than where blood vessels are concentrated, the length of the partial foot covering portion 110 is set so as not to exceed the base of the little toe or the head of the fifth metatarsal bone of a person having an average foot shape and a foot length of 22 cm. In such a case, when the sleep-promoting leg warmer 100 is worn, the partial foot covering portion 110 covers an area between 63.3% and 83.1% of the foot length from the heel side. The partial foot covering portion 110 is preferably knitted by a zokki-knitting method without use of back yean (FTY) from the viewpoint of being tightened gently so as not to cause discomfort. Further, from the same viewpoint, it is preferable that rubber yarn is inserted into this zokki-knitting. In addition, from the same viewpoint, it is preferable that, in this knitted fabric, the elongation rate in the cylinder axis direction is within a range of 140% or more and 160% or less, and the elongation rate in the width direction is within a range of 270% or more and 290% or less. Further, the circumference of the partial foot covering portion 110 is determined to be approximately the same as the foot circumference of a person with an average foot shape and a foot length of 23.5 cm. In addition, the sleep-promoting leg warmer 100 is knitted on a knitting machine with a cylinder diameter of about 5 inches, and thus the circumference of the partial foot covering portion 110 is larger than one knitted on a knitting machine with a cylinder diameter of about 3.5 inches, thereby reducing the tightness in the middle portion of the foot. Further, the wearing pressure of the partial foot covering portion 110 is preferably within a range of 9.50±0.49 hPa, and is more preferably within a range of 9.50±0.16 hPa. Note that this wearing pressure was measured at a room temperature of 20° C. and a relative humidity of 65% using PRESSURE CONVERTER AMI3037-10, a round air pack, and an HQL for the adult female average foot shape (a torso for the average human body size dummy MSX-20 manufactured by Nanasai Co., Ltd.'s).). Specifically, the round air pack is attached to the HQL for the adult female average foot shape, and one minute after wearing the sleep-promoting leg warmer 100 on the HQL with the round air pack attached, the wearing pressure measurement value displayed on the PRESSURE CONVERTER AMI3037-10 was read. Here, this measurement was performed three times and the average value was taken as the wearing pressure. This not only provides a firm texture, but also inhibits or reduces vertical expansion and contraction to prevent misalignment of the wearing position. This allows the partial foot covering portion 110 to fit the middle portion of the wearer's foot without excessively tightening the middle portion of the foot, and provide a comfortable feeling to the wearer. Moreover, this sleep-promoting leg warmer 100 has the above-described structure, thereby making it possible to inhibit or reduce misalignment.

### (2) First Press Fitting Portion

The first press fitting portion 120 is a cylindrical portion having a double knitted fabric structure, and covers the toe side of the heel part of the wearer; also the first press fitting portion 120 is a portion for preventing misalignment (slipping, rolling up, or the like) of the partial foot covering portion 110 and ankle covering portion 140 when the sleep-promoting leg warmer 100 is worn. As described above, the first press fitting portion 120 has a double knitted structure, and thus it has a heat retaining function due to the air layer existing between the layers. Note that, as shown in FIGS. 1 and 2, one end of the first press fitting portion 120 is connected to the partial foot covering portion 110, and the other end is connected to the connection portion 130. In addition, it is preferable that, from the viewpoint of inhibiting or reducing the misalignment as described above, the knitted fabric that knits the first press fitting portion 120 is determined to be a knitted fabric that is stronger in tightening than the knitted fabric that knits the partial foot covering portion 110 and the ankle covering portion 140. For this reason, it is preferable that the first press fitting portion 120 is knitted by plain knitting using back yean (FTY). Also, from the same viewpoint, it is preferable that rubber yarn or pattern yarn is inserted into this plain knitting. In addition, from the same viewpoint, it is preferable that, in this knitted fabric, the elongation rate in the cylinder axis direction is within a range of 240% or more and 260% or less, and the elongation rate in the width direction is within a range of 190% or more and 210% or less. Further, the wearing pressure applied by the first press fitting portion 120 is preferably within a range of 33.20±3.56 hPa, and is more preferably within a range of 33.20±1.19 hPa. This effectively prevents the partial foot covering portion 110 and the ankle covering portion 140 from be misaligned, thus allowing the partial foot covering portion 110 and the ankle covering portion 140 to fully function.

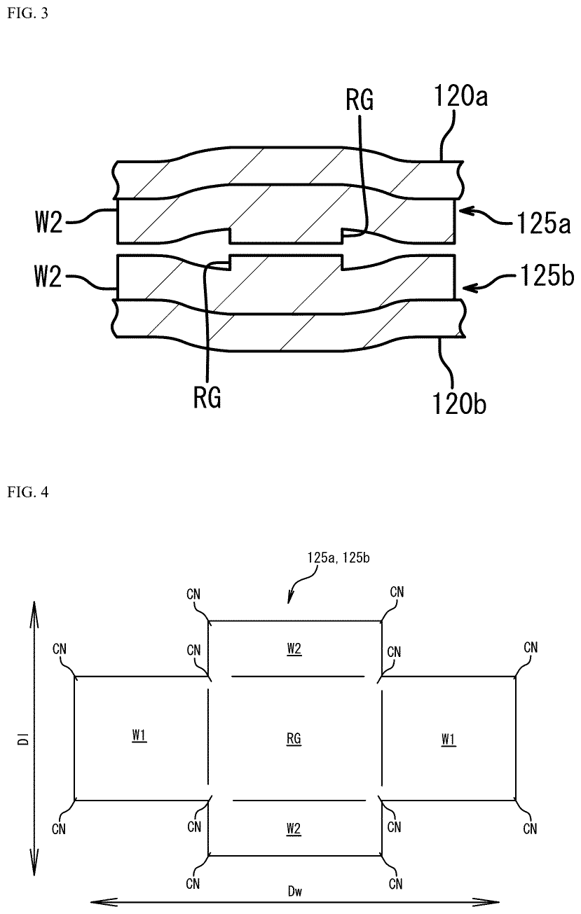

Further, as shown in FIGS. 1 and 2, on the sole-covered side of the first press fitting portion 120, a cross-shaped raised portion 125 is formed at a portion corresponding to an acupuncture point for insomnia. Note that, as described above, the first press fitting portion 120 has a double knitted fabric structure, and this double knitted fabric structure includes the inner knitted fabric layer 120a and the outer knitted fabric layer 120b as shown in FIG. 3. As shown in FIG. 3, the raised portion 125 include a first protrusion portion 125a that protrudes from the inner knitted fabric layer 120a toward the outer knitted fabric layer, and a second protrusion portion 125b that protrudes from the outer knitted fabric layer 120b toward the inner knitted fabric layer. As shown in FIG. 3, the first protrusion portion 125a and the second protrusion portion 125b are arranged to face each other. As shown in FIGS. 3 and 4, the first protrusion portion 125a and the second protrusion portion 125b includes a rectangular portion RG, a first wing portion W1, and a second wing portion W2. The rectangular portion RG is a rectangular parallelepiped-shaped portion composed of knitted fabric. As shown in FIG. 3, in the first protrusion 125a, the lower end surface of the rectangular portion RG is designed to be at a position lower than the lower end surface of the first wing portion W1 and lower end surface of the second wing portion W2; furthermore, in the second protrusion portion 125b, the upper end surface of the rectangular portion RG is designed to be at a higher position than the upper end surface of the first wing portion W1 and the upper end surface of the second wing portion W2. In other words, the rectangular portions RG in the first protrusion portion 125a and the second protrusion portion 125b are designed to be thicker than the first wing portion W1 and the second wing portion W2. The first wing portion W1 is a rectangular parallelepiped-shaped portion extending from the rectangular portion RG along the width direction D_{W} toward both sides of the rectangular portion RG, as shown in FIG. 4. As shown in FIG. 3, in the first protrusion portion 125a and the second protrusion portion 125b, the lower end surface or upper end surface of the first wing portion W1 is at the same height position as the lower end surface or upper end surface of the second wing portion W2. Further, as described above, the lower end surface of the first wing portion W1 of the first protrusion portion 125a is designed to be at a higher position than the lower end surface of the rectangular portion RG; furthermore, in the second protrusion portion 125b, the upper end surface of the first wing portion W1 is designed to be at a lower position than the upper end surface of the rectangular portion RG. In other words, the first wing portion W1 of the first protrusion portion 125a and the second protrusion portion 125b portion are designed to be thinner than the rectangular portion RG. The second wing portion W2 is a rectangular parallelepiped-shaped portion that extends from the rectangular portion RG toward both sides of the rectangular portion RG along the direction D1 orthogonal to the width direction D_{W}, that is, the depth direction (direction passing through the heel and toe), as shown in FIG. 4. As shown in FIG. 3, in the first protrusion portion 125a and the second protrusion portion 125b, the lower end surface or upper end surface of the second wing portion W2 is at the same height position as the lower end surface or upper end surface of the second wing portion W2. Further, as described above, in the first protrusion portion 125a, the lower end surface of the first wing portion W1 is designed to be at a higher position than the lower end surface of the rectangular portion RG; furthermore, in the second protrusion portion 125b, the upper end surface of the first wing portion W1 is designed to be at a lower position than the upper end surface of the rectangular portion RG. In other words, in the first protrusion portion 125a and the second protrusion portion 125b, the second wing portion W2 is designed to be thinner than the rectangular portion RG. Forming the first protrusion portion 125a and the second protrusion portion 125b as described above causes twelve corners CN to be formed in each of the first protrusion portion 125a and the second protrusion portion 125b. Note that four of the corners CN are formed by the rectangular portion RG, and eight of the corners CN are formed by the first wing portion W1 and the second wing portion W2.

Forming the raised portion 125 as described above causes the raised portion 125 formed by the first protrusion portion 125a and the second protrusion portion 125b portion to rise toward the inside (skin side) when the wearer wears it and walks, or the like, (In such a case, the upper end surfaces of the rectangular portions formed by the rectangular portion RG of the first protrusion portion 125a and the rectangular portion RG of the second protrusion portion 125b are located higher than the upper end surface of the first wing portion formed by the first wing portion W1 of the first protrusion portion 125a and the first wing portion W1 of the second protrusion portion 125b, and the upper end surface of the second wing portion formed by the second wing portion W2 of the first protrusion portion 125a and the second wing portion W2 of the second protrusion portion 125b.) and causes 12 corners to be formed at positions corresponding to each corner CN of the first protrusion portion 125a and the second protrusion portion 125b in the raised portion, thereby allowing these corners to efficiently stimulate the acupuncture point for insomnia.

Note that when the protrusion portions 125a and 125b are formed with knitted fabric, the protrusion portions 125a and 125b are preferably formed as follows. Specifically, the protrusion portions 125a and 125b are knitted using a combination of knitting methods, such as pile knitting, and yarn variations, such as thick yarn. This allows the first protrusion portion 125a to be integrated with the inner knitted fabric layer 120a, and also allows the second protrusion portion 125b to be integrated with the outer knitted fabric layer 120b, thus inhibiting or reducing misalignment of the protrusion portions 125a and 125b due to poor adhesion or the like without increasing the formation process of the protrusion portions 125a and 125b.

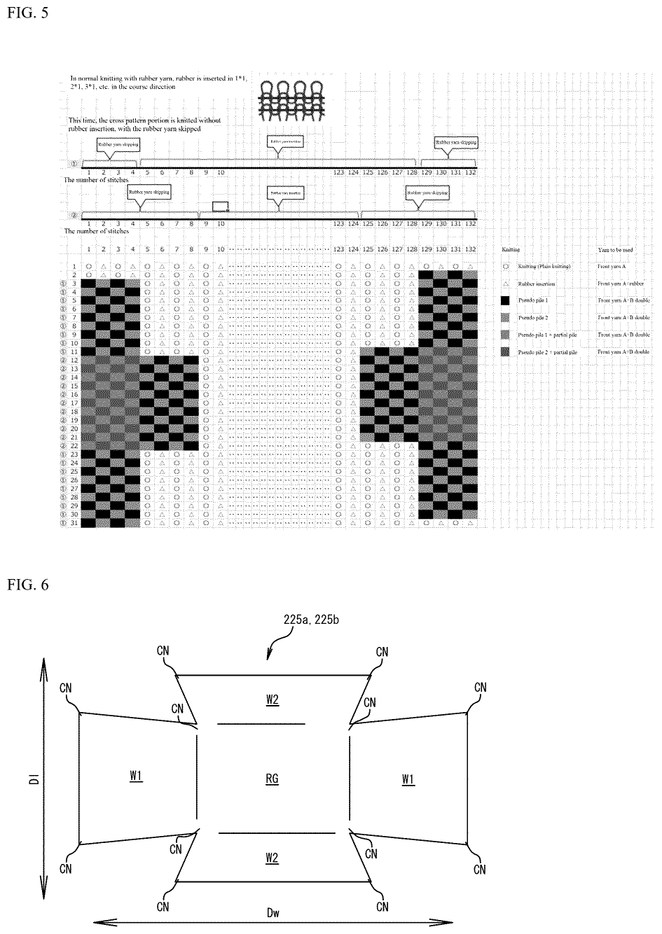

A more specific knitting method is shown in FIG. 5. In FIG. 5, the areas indicated by symbols each expressed as a circle (O mark) and symbols each expressed as a triangle (hereinafter the area may be referred to as “first area”) is a plain knitting area and is knitted with front yarn, back yarn and rubber yarn. Rubber yarn is inserted at the locations marked with the symbols each expressed as a triangle.

The area indicated by row numbers 3 to 11/column numbers 1 to 4 (hereinafter may be referred to as “21st area”), the area indicated by row numbers 12 to 22/column numbers 5 to 8 (hereinafter may be referred to as “22nd area”), the area indicated by row numbers 23 to 31/column numbers 1 to 4 (hereinafter may be referred to as “23rd area”), the area indicated by row numbers 3 to 11/column numbers 129 to 132 (hereinafter may be referred to as the “24th area”), the area indicated by row numbers 12 to 22/column numbers 125 to 128 (hereinafter may be referred to as the “25th area”), the area indicated by row numbers 23 to 31/column numbers 129 to 132 (hereinafter may be referred to as the “26th area”) are knitted with front yarn, back yarn, rubber yarn, and pseudo pile yarn. Note that, in these areas, the pseudo pile yarn is woven in the gray areas, but not in the black areas. The pseudo pile yarn is not woven in the black areas, thereby causing the fabric in those areas to become pile-like and thick. Also, the rubber yarn is not woven into these areas, and thus the rubber yarn lies on top of these areas. Since the rubber yarn is not woven in this way, the rubber yarn is not pressed and the thickness is increased accordingly.

The area indicated by row numbers 12 to 22/column numbers 1 to 4 (hereinafter may be referred to as “31st area”), the area indicated by row numbers 12 to 22/column numbers 129 to 132 (hereinafter may be referred to as the “32nd area”) is knitted with front yarn, back yarn, rubber yarn, and pseudo pile yarn. Note that, in these areas, the pseudo pile yarn is woven in light gray areas, but is not woven in dark gray areas. This point is the same as the above-mentioned 21st to 26th areas, but in these areas, the plain knitting is further changed to pile knitting. As a result, these areas become thicker than the 21st to 26th areas. In other words, the relationship between the thicknesses of each area described above is as follows.
31st area=32nd area>21st area=22nd area=23rd area=24th area=25th area=26th area>first area.

Further, in the 31st area and the 32nd area, rubber yarn is not woven as in the 21st to 26th areas, and thus the rubber yarn lies on these areas. Since the rubber yarn is not woven in this way, the rubber yarn is not pressed and the thickness is increased accordingly.

### (3) Connection Portion

The connection portion 130 is an annular portion having a single knitted fabric structure, and plays a role of connecting the first press fitting portion 120 and the ankle covering portion 140. From the viewpoint of not disturbing the wearer's sleep, it is preferable that the connection portion 130 has no level difference and does not make the wearer feel tight. Note that specific examples of the connection portion 130 include a heat-sealed portion, a sewn portion, and the like. Note that the connection portion 130 is preferably located closer to the toe than the heel of the wearer when the sleep-promoting leg warmer 100 is worn. This is because, from the viewpoint of not causing discomfort to the wearer, it is preferable for the connection portion 130 to be located at a non-sensitive portion of the wearer's foot when the sleep-promoting leg warmer 100 is worn.

### (4) Ankle Covering Portion

The ankle covering portion 140 is a cylindrical portion having a single knitted fabric structure, and is a portion for covering the wearer's ankle and part of the heel. Note that, as shown in FIGS. 1 and 2, the ankle covering portion 140 is connected to the first press fitting portion 120 via the connection portion 130, and the opposite side thereof is connected to the second press fitting portion 150. Further, the ankle covering portion 140 is preferably knitted by pile knitting or the like from the viewpoint of providing adequate heat retention. Further, from the viewpoint of aligning the raised portion 125 of the first press fitting portion 120, the ankle covering portion 140 is preferably bent so as to follow the shape of the ankle and heel during sleep. In the ankle covering portion 140, it is preferable to provide a reducing knitting area between the entire circumference knitting areas of the ankle covering portion 140, and an increasing knitting area may be provided following the reducing knitting area. Further, the wearing pressure of the ankle covering portion 140 is preferably within a range of 8.17±2.62 hPa or less, and is more preferably within a range of 8.17±0.87 hPa or less.

### (5) Second Press Fitting Portion

The second press fitting portion 150 is a cylindrical portion having a single knitted fabric, and covers a portion located above the ankle of the wearer; furthermore, the second press fitting portion 150 is a portion for inhibiting or reducing misalignment of the ankle covering portion 140 and the shin covering portion 160 (slipping down, rolling up, or the like) when the sleep-promoting leg warmer 100 is worn. Note that, as shown in FIGS. 1 and 2, one end of the second press fitting portion 150 is connected to the ankle covering portion 140, and the other end is connected to the shin covering portion 160. Further, the wearing pressure of the second press fitting portion 150 is preferably within a range of 5.63±0.51 hPa or less, and is more preferably within a range of 5.63±0.17 hPa or less.

Further, as shown in FIGS. 1 and 2, an acupuncture point stimulation portion 155 is formed on the side surface of the second press fitting portion 150 at a position corresponding to the Sanyinjiao acupuncture point.

### (6) Shin Covering Portion

The shin covering portion 160 is a cylindrical portion having a double knitted fabric structure, and is a portion for covering the wearer's shin. As described above, the shin covering portion 160 has a double knitted fabric structure, and thus it has a heat retention function due to the air layer existing between the layers. Note that, as shown in FIGS. 1 and 2, one end of the shin covering portion 160 is connected to the second press fitting portion 150, and the other end is the base end of the sleep-promoting leg warmer 100. In addition, from the viewpoint of inhibiting or reducing the misalignment of the shin covering portion 160 (slipping down, rolling up, or the like) when the sleep-promoting leg warmer 100 is worn, the wearing pressure of the shin covering portion 160 is within a range of 4.80±3.13 hPa or less, and is more preferably within a range of 4.80±1.04 hPa or less.

### <Wearing Pressure Ratio of Each Portion>

As described above, preferred wearing pressures are prescribed for each portion, but the ratio of these, that is, the wearing pressure of the shin covering portion 160: the wearing pressure of the ankle covering portion 140: the wearing pressure of the partial foot covering portion 110: the wearing pressure of the second press fitting portion 150: the wearing pressure of the first press fitting portion 120 is preferably 4.80±3.13 hPa: 8.17±2.62 hPa: 9.50±0.49 hPa: 5.63±0.51 hPa: 33.20±3.56 hPa, and is more preferably 4.80±1.04 hPa: 8.17±0.87 hPa: 9.50±0.16 hPa: 5.63±0.17 hPa: 33.20±1.19 hPa. In other words, it is preferable that the wearing pressure of the first press fitting portion 120 is higher than the wearing pressure of the partial foot covering portion 110, the wearing pressure of the first press fitting portion 120 is higher than the wearing pressure of the ankle covering portion 140, the wearing pressure of the ankle covering portion 140 is higher than the wearing pressure of the second press fitting portion 150, and the wearing pressure of the second press fitting portion 150 is higher than the wearing pressure of the shin covering portion 160.

### <Specific Method for Forming the Sleep-Promoting Leg Warmer According to an Embodiment of the Present Invention>

Examples of methods for forming the partial foot covering portion 110 and the first press fitting portion 120 include (i) a method of knitting the outer knitted fabric layer 120b of the first press fitting portion 120 by knitting from the end of the first press fitting portion 120 on the side toward the connection portion to the end of the first press fitting portion 120 on the side toward the partial foot covering portion, then switching the yarn and knitting from the end of the partial foot covering portion 110 on the side toward the first press fitting portion to the tip of the partial foot covering portion 110 to knit the outer knitted layer of the partial foot covering portion 110, knitting the inner knitted layer of the partial foot covering portion 110 by knitting from the tip of the partial foot covering portion 110 to the end of the partial foot covering portion 110 on the side toward the first press fitting portion, then switching the yarn and knitting from the end of the first press fitting portion 120 on the side toward the partial foot covering portion to the end of the first press fitting portion 120 on the side toward the connection portion to knit the inner knitted fabric layer 120a of the first press fitting portion 120, and pressing the inner knitted fabric layer of the partial foot covering portion 110 and the first press fitting portion 120 into the outer knitted fabric layer of the partial foot covering portion 110 and the first press fitting portion 120; and (ii) a method of knitting the inner knitted fabric layer 120a of the first press fitting portion 120 by knitting from the end of the first press fitting portion 120 on the side toward the connection portion to the end of the first press fitting portion 120 on the side toward the partial foot covering portion, then switching the yarn and knitting from the end of the partial foot covering portion 110 on the side toward the first press fitting portion to the tip of the partial foot covering portion 110 to knit the inner knitted layer of the partial foot covering portion 110, knitting the outer knitted layer of the partial foot covering portion 110 by knitting from the tip of the partial foot covering portion 110 to the end of the partial foot covering portion 110 on the side toward the first press fitting portion, then switching the yarn and knitting from the end of the first press fitting portion 120 on the side toward the partial foot covering portion to the end of the first press fitting portion 120 on the side toward the connection portion to knit the outer knitted fabric layer 120b of the first press fitting portion 120, and pressing the inner knitted fabric layer of the partial foot covering portion 110 and the first press fitting portion 120 into the outer knitted fabric layer of the partial foot covering portion 110 and the first press fitting portion 120.

Examples of methods for forming the ankle covering portion 140, the second press fitting portion 150, the shin covering portion 160 include (i) a method of knitting the ankle covering portion 140 by knitting from the end of the ankle covering portion 140 on the side toward the connection portion to the end of the ankle covering portion 140 on the side toward the second press fitting portion, then switching the yarn and knitting from the end of the second press fitting portion 150 on the side toward the ankle covering portion to the end of the second press fitting portion 150 on the side toward the shin covering portion to knit the second press fitting portion 150, then switching the yarn and knitting from the end of the shin covering portion 160 on the side toward the second press fitting portion to the base end of the shin covering portion 160 to knit the outer knitted layer of the shin covering portion 160, then knitting the inner knitted layer of the shin covering portion 160 by knitting from the base end of the shin covering portion 160 to the end of the shin covering portion 160 on the side toward the second press fitting portion, and pressing the inner knitted layer of the shin covering portion 160 into the outer knitted layer of the shin covering portion 160 to connect the inner knitted layer and the outer knitted layer at the end on the side toward the second press fitting portion; and (ii) a method of knitting the inner knitted layer of the shin covering portion 160 by knitting from the end of the shin covering portion 160 on the side toward the second press fitting portion to the base end of the shin covering portion 160, then knitting the outer knitted layer of the shin covering portion 160 by knitting from the base end of the shin covering portion 160 to the end of the shin covering portion 160 on the side toward the second press fitting portion, then switching the yarn and knitting from the end of the second press fitting portion 150 on the side toward the shin covering portion to the end of the second press fitting portion 150 on the side toward the ankle covering portion to knit the second press fitting press fitting portion 150, then switching the yarn and knitting from the end of the ankle covering portion 140 on the side toward the second press fitting portion to the end of the ankle covering portion 140 on the side toward the connection portion to knit the ankle covering portion 140, and pressing the inner knitted layer of the shin covering portion 160 into the outer knitted layer of the shin covering portion 160 to connect the inner knitted layer and the outer knitted layer at the end on the side toward the second press fitting portion.

The method of connecting the first press fitting portion 120 and the ankle covering portion 140 is as described in the above-mentioned “(3) Connection portion.”

### <Features of the Sleep-Promoting Leg Warmer According to an Embodiment of the Present Invention>

(1)

In the sleep-promoting leg warmer 100 according to an embodiment of the present invention, a raised portion 125 is provided at a position corresponding to the acupuncture point for insomnia on the first press fitting portion 120, and corners are formed in the raised portion 125. Thus, the sleep-promoting leg warmer 100 can make the wearer perceive that the acupuncture pressure point for insomnia is stimulated more effectively than previous ones by wearing it before bedtime or by the wearer walking lightly before bedtime.

(2)

In the sleep-promoting leg warmer 100 according to an embodiment of the present invention, the raised portion 125 is composed of the first protrusion portion 125a that protrudes from the inner knitted fabric layer 120a toward the outer knitted fabric layer, and the second protrusion portion 125b that protrudes from the outer knitted fabric layer 120b toward the inner knitted fabric layer. Thus, even if yarn comes out during knitting of the protrusion portions 125a and 125b, the sleep-promoting leg warmer 100 can prevent the yarn from being exposed on the skin side or the ground surface side. As a result, the sleep-promoting leg warmer 100 can prevent the yarn forming the protrusion portions 125a and 125b from getting caught on the wearer's nails, fingers, or the floor. Thus, the sleep-promoting leg warmer 100 is easy to wear and the yarn is difficult to unravel.

(3)

In the sleep-promoting leg warmer 100 according to an embodiment of the present invention, wearing pressures have been applied as follows: the wearing pressure of the shin covering portion 160: the wearing pressure of the ankle covering portion 140: the wearing pressure of the partial foot covering portion 110; the wearing pressure of the second press fitting portion 150: the wearing pressure of the first press fitting portion 120 is 4.80±3.13 hPa: 8.17±2.62 hPa: 9.50±0.49 hPa: 5.63±0.51 hPa: 33.20±3.56 hPa. As a result of extensive research by the inventors of the present application, it has become clear that the sleep-promoting leg warmer 100 having such a ratio for wearing pressures does not compress the wearer's feet, ankles, upper ankle parts, or shins to an uncomfortable degree, and is unlikely to slip off from the wearer's feet, ankles, upper ankle parts, or shins while falling asleep or sleeping. Thus, the sleep-promoting leg warmer 100 is unlikely to slip off from the feet, ankles, upper ankle parts, and shins during falling asleep or sleeping, and can provide the wearer with a comfortable falling asleep and sleeping.

(4)

In the sleep-promoting leg warmer 100 according to an embodiment of the present invention, there is no wearing pressure area stronger than the partial foot covering portion 110 on the side opposite to the first press fitting portion side of the partial foot covering portion 110. Conversely, in conventional footwear items, a wearing pressure area that is stronger than the part corresponding to the partial foot covering portion is often provided on the tip side of the part corresponding to the partial foot covering portion to prevent it from slipping when worn.

### MODIFICATIONS

### (A)

The sleep-promoting leg warmer 100 according to the previous embodiment was dimensionally designed assuming a wearer whose foot length was within a range of 22 cm or more and 25 cm or less, but the dimension range thereof may be designed in units of 1 cm, for example. In other words, for example, three different dimensions may be designed for a wearer whose foot length is within a range of 22 cm or more and 23 cm or less, a wearer whose foot length is within a range of 23 cm or more and 24 cm or less, and a wearer whose foot length is within a range from 24 cm or more and 25 cm or less, respectively.

### (B)

In the sleep-promoting leg warmer 100 according to the previous embodiment, the length of the partial foot covering portion 110 is the same as that of a person with an average foot shape and a foot length within a range from 22 cm to 25 cm inclusive, and the length does not exceed the base of the little toe; however, the length of the partial foot covering portion 110 may be the length that covers up the tip of the little toe of a person with an average foot shape and a foot length of 22 cm. In this case, when a person with an average foot shape and a foot length of 25 cm wears the sleep-promoting leg warmer 100, the area up to the base of the little toe will be covered.

### (C)

In the sleep-promoting leg warmer 100 according to the previous embodiment, the partial foot covering portion 110 has been designed to cover the entire circumference of the heel-side portion of the foot of wearer; however, the sleep-promoting leg warmer 100 may be designed to cover at least part of the outer toes or at least all of the outer toes.

### (D)

In the sleep-promoting leg warmer 100 according to the previous embodiment, the first press fitting portion 120 has been provided between the partial foot covering portion 110 and the connection portion 130 for the purpose of inhibiting or reducing misalignment of the partial foot covering portion 110 and the ankle covering portion 140; however, the first press fitting portion may be provided on the toe side of the partial foot covering portion 110 for the purpose of inhibiting or reducing misalignment of only the partial foot covering portion 110, or the first press fitting portion may be provided inside the ankle covering portion 140 for the purpose of inhibiting or reducing misalignment of only the ankle covering portion 140. Note that, in the former case, it is preferable to use a knitting structure similar to that of general single-knit open toe socks, and in the latter case, it is preferable to use a knitting structure similar to that of a double-welted bag-like portion as disclosed in U.S. Pat. No. 6,195,139.

### (E)

In the sleep-promoting leg warmer 100 according to the previous embodiment, the partial foot covering portion 110, the first press fitting portion 120, and the shin covering portion 160 have a double knitted fabric structure, but these portions 110, 120, and 160 may have a single knitted structure. In such a case, the partial foot covering portion 110 is preferably knitted with a knitted fabric with high heat retention such as pile knitting, or it is preferably knitted with yarn with high heat retention such as acrylic yarn or wool, or it is preferably knitted with moisture absorbing heat generating yarn such as eks (registered trademark).

### (F)

In the sleep-promoting leg warmer 100 according to the previous embodiment, the partial foot covering portion 110, the first press fitting portion 120, and the shin covering portion 160 have a double knitted fabric structure, but these portions 110, 120 and 160 may have a triple knitted fabric structure or more. In such a case, yarns of different materials may be used for each knitted fabric layer to adjust its heat retention and other properties.

### (G)

In the sleep-promoting leg warmer 100 according to the previous embodiment, the connection portion 130, the ankle covering portion 140, and the second press fitting portion 150 have a single knitted fabric structure, but these portions 130, 140 and 150 may also have a double knitted fabric structure.

### (H)

Although not specifically mentioned in the previous embodiment, the heel side area of the partial foot covering portion 110 may be knitted into a heat generating or heat retaining fabric, and the partial foot covering portion 110 may be knitted into a fabric with gradually lower heat generating or heat retaining properties toward the tip side. By knitting the partial foot covering portion 110 in this manner, the wearer's body temperature can be increased while avoiding overheating the area around the toes, where heat needs to be dissipated, thereby achieving efficient heat dissipation.

### (I)

In the sleep-promoting leg warmer 100 according to the previous embodiment, the shape of the raised portion 125 is a cross column shape, but the shape of the raised portion should not be particularly limited as long as it has corners, and may be, for example, polygonal in shape, such as triangular, square, pentagonal, hexagonal, octagonal, or star-shaped columns, or cylindrical. Note that it is not necessary that the corners of the raised portion 125 are recognizable only in plan view, but it is sufficient that they are recognizable when viewed from all directions of 360°. Further, in such a shape, the corners may be rounded, but from the viewpoint of effectively stimulating the acupuncture point for insomnia, it is preferable that the radius of the rounded corners is 15 mm or less. Although the lower limit of the radius of the rounded corner is not particularly defined, it is, for example, 0.1 mm.

### (J)

In the sleep-promoting leg warmer 100 according to the previous embodiment, only one relatively large raised portion 125 is provided, but a plurality of relatively small raised portions may be provided.

### (K)

In the sleep-promoting leg warmer 100 according to the previous embodiment, the lower end surface of the rectangular portion RG in the first protrusion portion 125a is designed to be at a lower position than the lower end surface of the first wing portion W1 and the lower end surface of the second wing portion W2, and in the second protrusion portion 125b, the upper end surface of the rectangular portion RG is designed to be at a higher position than the upper end surface of the first wing portion W1 and the upper end surface of the second wing portion W2; but in the first protrusion portion 125a, the lower end surface of the rectangular portion RG may be at the same height as the lower end surface of the first wing portion W1 and the lower end surface of the second wing portion W2, and in the second protrusion portion 125b, the upper end surface of the rectangular portion RG may be at the same height as the upper end surface of the first wing portion W1 and the upper end surface of the second wing portion W2 (that is, the surfaces facing each other in the first and second protrusion portions 125a and 125b may be flat (flat surface). In other words, the rectangular portion RG may be the same thickness as the first and second wing portions W1 and W2 in the first and second protrusion portions 125a and 125b.); in the first protrusion portion 125a, the lower end surface of the rectangular portion RG may be designed to be at a higher position than the lower end surface of the first wing portion W1 and the lower end surface of the second wing portion W2, and in the second protrusion portion 125b, the upper end surface of the rectangular portion RG is designed to be at a lower position than the upper end surface of the first wing portion W1 and the upper end surface of the second wing portion W2 (that is, in the first protrusion portion 125a and the second protrusion portion 125b, the rectangular portion RG may be made thinner than the first wing portion W1 and the second wing portion W2.

### (L)

In the sleep-promoting leg warmer 100 according to the previous embodiment, the first protrusion portion 125a protrudes from the inner knitted fabric layer 120a toward the outer knitted fabric layer, and the second protrusion portion 125b protrudes from the outer knitted fabric layer 120b to the inner knitted fabric layer; however, the first protrusion portion may protrude inward from the inner knitted fabric layer 120a, that is, towards the skin side, and the second protrusion portion may protrude from the outer knitted fabric layer 120b towards the inner knitted fabric layer; alternatively, the first protrusion portion may protrude from the inner knitted fabric layer 120a toward the outer knitted fabric layer, and the second protrusion portion may protrude from the outer knitted fabric layer 120b toward the outside, that is, the side opposite to the skin side; alternatively, the first protrusion portion may protrude from the inner knitted fabric layer inward, that is, toward the skin side, and the second protrusion portion 125b may protrude from the outer knitted fabric layer 120b toward the outside, that is, the side opposite to the skin side. Note that in any of the above cases, the first protrusion portion and the second protrusion portion need to overlap in plan view.

### (M)

In the sleep-promoting leg warmer 100 according to the previous embodiment, the first press fitting portion 120 have a double knitted fabric structure, and the protrusion portions 125a and 125b are formed therebetween; however, the first press fitting portion 120 may have a single knitted fabric structure, and protrusion(s) may be formed on the inside (skin side) or outside.

### (N)

In the sleep-promoting leg warmer 100 according to the previous embodiment, the corners CN of the first wing portion W1 and the second wing portion W2 of the protrusion portions 125a and 125b are right angles; however, instead of the protrusion portions 125a and 125b, as shown in FIG. 6, protrusions 225a and 225b may be provided in which the corners CN of the first wing portion W1 and the second wing portion W2 are acute angles. Further, the corners CN may be obtuse angles, but if the obtuse angles are too large, the effect of the present invention will be weakened, which is not so preferable. Further, although the corners CN of the rectangular portion RG of the protrusion portions 125a and 125b are right angles, the corners CN of the rectangular portion RG may be acute angles. Further, the corners CN may be obtuse angles, but if the obtuse angles are too large, the effect of the present invention will be weakened, which is not so preferable.

### (O)

In the sleep-promoting leg warmer 100 according to the previous embodiment, the raised portion 125 has been composed of knitted fabric, but the raised portion 125 may be formed of, for example, vinyl chloride resin, silicone resin, elastomer resin, rubber, or the like. In such a case, the raised portion 125 may be formed of resin or rubber containing magnetic particles or magnetic powder in order to have magnetic health effects.

### (P)

In the sleep-promoting leg warmer 100 according to the previous embodiment, the raised portion 125 stimulates the acupuncture point for insomnia with pressure; but the raised portion may stimulate the acupuncture point for insomnia with heat, it may stimulate the acupuncture point for insomnia with cold, or it may stimulate the acupuncture point for insomnia with electricity. Further, the raised portion may stimulate the acupuncture point for insomnia with pressure and heat. To provide the raised portion with a thermal stimulation function, it is necessary to knit the raised portion using acrylate fiber, wool, cupra (registered trademark), rayon (registered trademark), or the like, as yarn having heat generating properties.

### (Q)

In the sleep-promoting leg warmer 100 according to the previous embodiment, the raised portion 125 has been provided at the position corresponding to the acupuncture point for insomnia, but it may be provided at a position corresponding to the Sanyinjiao acupuncture point, Yongquan acupuncture point or the like.

### (R)

In the sleep-promoting leg warmer 100 according to the previous embodiment, the cross-shaped raised portion 125 has been formed on the sole covering side of the first press fitting portion 120, but an X-shaped raised portion may be formed. In the X-shaped raised portion, the first wing portion and the second wing portion do not extend along the cylinder axis and width direction as shown in FIG. 2, but rather they extend along directions inclined 45 degrees to those directions. Note that the first wing portion and the second wing portion of the X-shaped raised portion may extend along directions other than those described above.

### (S)

In the sleep-promoting leg warmer 100 according to the above embodiment, the partial foot covering portion 110 is dimensionally designed for those who have an average foot shape and whose foot length is within a range of 22 cm more and 25 cm or less; however, it may be dimensionally designed for a person with other foot shapes or foot lengths.

Note that each of the above-described modifications may be employed alone, or may be employed in appropriate combinations as long as there is no contradiction.

1. A footwear item comprising:
a heel covering portion; and
at least one raised portion that protrudes toward at least one of an inner side and an outer side of the heel covering portion;
wherein the raised portion has a corner.

2. The footwear item according to claim 1,
wherein the raised portion has a polygonal shape.

3. The footwear item according to claim 2,
wherein the raised portion has a cross shape in plan view.

4. The footwear item according to claim 3, wherein
the raised portion includes a rectangular portion having a rectangular shape when seen in plan view, a first wing portion extending from the rectangular portion toward both sides along a width direction, and a second wing portion extending from the rectangular portion toward both sides along a direction perpendicular to the width direction in plan view, and
an upper end surface of the rectangular portion is located at a higher position than an upper end surface of the first wing portion and an upper end surface of the second wing portion.

5. The footwear item according to claim 1, wherein
the heel covering portion is formed with an inner knitted fabric layer and an outer knitted fabric layer, and
the raised portion is located between the inner knitted fabric layer and the outer knitted fabric layer.

6. The footwear item according to claim 5,
wherein the raised portion includes a first protrusion portion that protrudes from the inner knitted fabric layer toward the outer knitted fabric layer, and a second protrusion portion that protrudes from the outer knitted fabric layer toward the inner knitted fabric layer and faces the first protrusion portion.

7. The footwear item according to claim 1, wherein the footwear item is for promoting falling asleep.

8. The footwear item according to claim 7, wherein the footwear item has a cylindrical shape with openings on both sides.

9. The footwear item according to any one of claim 2, wherein
the heel covering portion is formed with an inner knitted fabric layer and an outer knitted fabric layer, and
the raised portion is located between the inner knitted fabric layer and the outer knitted fabric layer.

10. The footwear item according to claim 9,
wherein the raised portion includes a first protrusion portion that protrudes from the inner knitted fabric layer toward the outer knitted fabric layer, and a second protrusion portion that protrudes from the outer knitted fabric layer toward the inner knitted fabric layer and faces the first protrusion portion.

11. The footwear item according to any one of claim 3, wherein
the heel covering portion is formed with an inner knitted fabric layer and an outer knitted fabric layer, and
the raised portion is located between the inner knitted fabric layer and the outer knitted fabric layer.

12. The footwear item according to claim 11,
wherein the raised portion includes a first protrusion portion that protrudes from the inner knitted fabric layer toward the outer knitted fabric layer, and a second protrusion portion that protrudes from the outer knitted fabric layer toward the inner knitted fabric layer and faces the first protrusion portion.

13. The footwear item according to any one of claim 4, wherein
the heel covering portion is formed with an inner knitted fabric layer and an outer knitted fabric layer, and
the raised portion is located between the inner knitted fabric layer and the outer knitted fabric layer.

14. The footwear item according to claim 13,
wherein the raised portion includes a first protrusion portion that protrudes from the inner knitted fabric layer toward the outer knitted fabric layer, and a second protrusion portion that protrudes from the outer knitted fabric layer toward the inner knitted fabric layer and faces the first protrusion portion.
